(19) United States
(12) Patent Application Publication
(10) Pub. No.: US 2021/0268629 A1
(43) Pub. Date: Sep. 2, 2021

(54) RATCHET WRENCH

(71) Applicant: JEN-YU WANG, Taichung City (TW)

(72) Inventor: JEN-YU WANG, Taichung City (TW)

(21) Appl. No.: 16/805,875

(22) Filed: Mar. 2, 2020

(51) Int. Cl. B25B 13/46; B25B 23/00

(52) U.S. Cl. CPC B25B 13/463; B25B 23/0007

(57) ABSTRACT

A ratchet wrench includes a through hole defined through the head of the wrench and a recess is defined in the inner periphery of the through hole. A circular hole is defined through the head and communicates with the recess. A ratchet wheel is rotatably received in the through hole of the head. A pawl is movably located in the recess and engaged with the ratchet wheel. A switch member is rotatable inserted into the circular hole and has a lever located outside of the head of the wrench. A slot is defined transversely in the switch member. The slot is located corresponding to the recess. The switch member receives one end of a spring which biases a tubular member contact the pawl. The pawl has a flange which is located in the slot such that the switch member does not drop from the circular hole.

### BACKGROUND OF THE INVENTION

### 1. Fields of the Invention

The present invention relates to a ratchet wrench, and more particularly, to a switch member of a ratchet wrench.

### 2. Descriptions of Related Art

The conventional ratchet wrench as disclosed in Taiwanese Patent No. I 670147, which discloses a switch member that is able to be pivoted to change the ratcheting direction of the ratchet wrench. The switch member includes an insertion portion inserted into the head of the wrench, and the insertion portion is located between two pawls. Each pawl is biased by a spring to clamp the insertion portion between the two pawls. The spring force of each spring has to be strong enough to avoid the switch member from being pivoted by impact or the like. However, the strong springs make the switch member difficult to be operated. Besides, the switch member does not have a proper mechanism to avoid it from dropping out from the head of the wrench

The present invention intends to provide a ratchet wrench to eliminate the shortcomings mentioned above.

### SUMMARY OF THE INVENTION

The present invention relates to a ratchet wrench and comprises a handle and a head which is formed to one end of the handle. The head includes a through hole which forms a first opening and a second opening in two opposite sides of the head. A recess is defined in the inner periphery of the through hole. A circular hole is defined through a neck of the head and communicates with the recess. A ratchet wheel is rotatably received in the through hole of the head and located corresponding to the first and second openings. A switch member has a head end, a tail end and a connection portion that is formed between the head end and the tail end. A lever extends from the head end. The tail end has an extension portion extending therefrom and toward the head end. The tail end, the extension portion and a portion of the connection portion are inserted into the circular hole, and are located in the recess. The head end and the lever are located outside of the head. A first width of the head end is larger than a second width of the tail end. The connection portion is tapered from the head end toward the tail end. A gap is formed between the connection portion and the inside of the recess.

A pawl is movably located in the recess, and has a toothed front face and a curved-recessed back which is located opposite to the toothed front face. The pawl is located between the ratchet wheel and the switch member. The toothed front face of the pawl is engaged with the ratchet wheel. A flange extends from the curved-recessed back and is located between the head end and the extension portion. The flange restricts the switch member from dropping from the circular hole. A tubular member has a first end thereof contacting the curved-recessed back, and a spring is biased between a second end of the tubular member and the extension portion.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the ratchet wrench of the present invention;

FIG. 2 is a perspective view to show the head and a section of the handle of the ratchet wrench of the present invention;

FIG. 3 is a side view to illustrate the switch member of the ratchet wrench of the present invention;

FIG. 4 shows another perspective view of the pawl of the ratchet wrench of the present invention;

FIG. 5 is a cross sectional view, taken along line V-V in FIG. 2;

FIG. 6 is a cross sectional view, taken along line VI-VI in FIG. 2;

FIG. 7 shows that the lever of the switch member is pivotable within the fan-shaped recessed area;

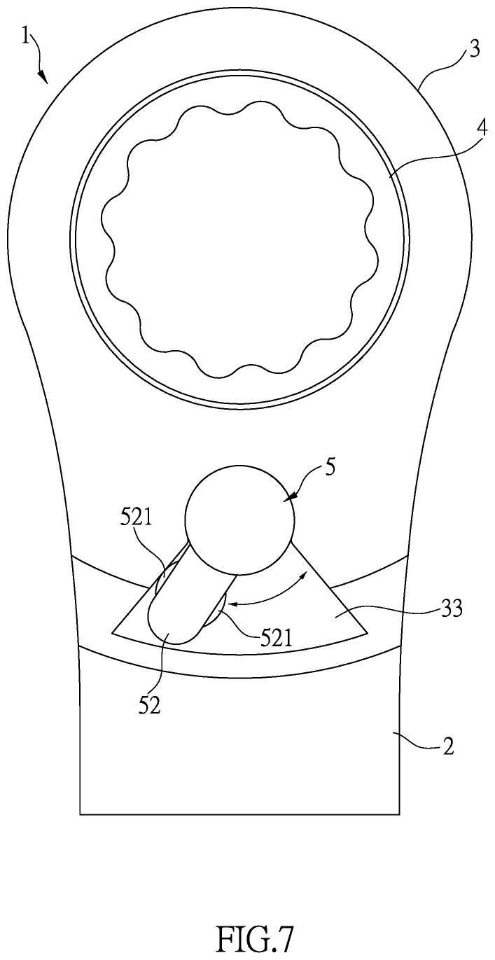

FIG. 8 shows another embodiment of the switch member of the ratchet wrench of the present invention;

FIG. 9 is an end view of the switch member in FIG. 8, and

FIG. 10 is a cross sectional view to show that the switch member in FIG. 8 is used in the ratchet wrench of the present invention.

### DETAILED DESCRIPTION OF THE PREFERRED EMBODIMENT

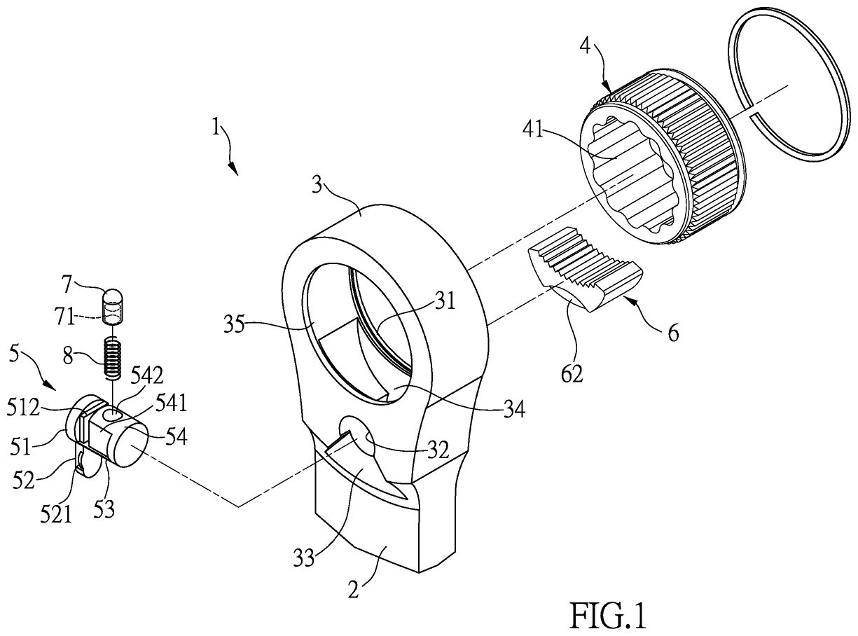

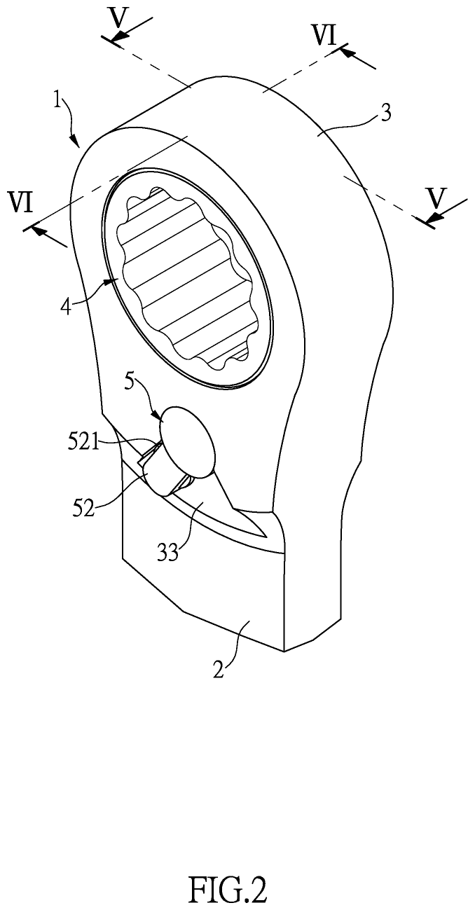

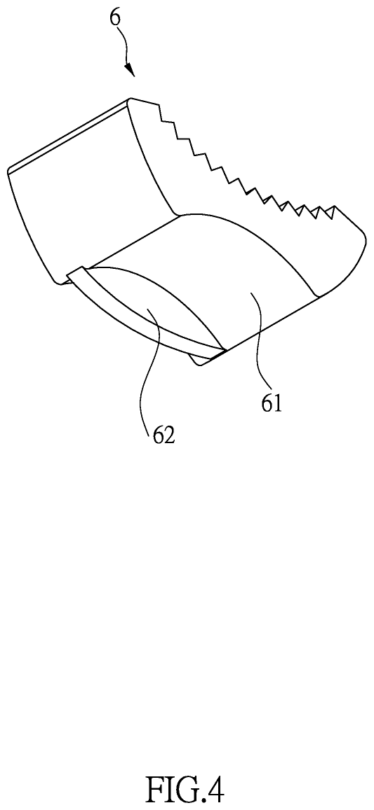

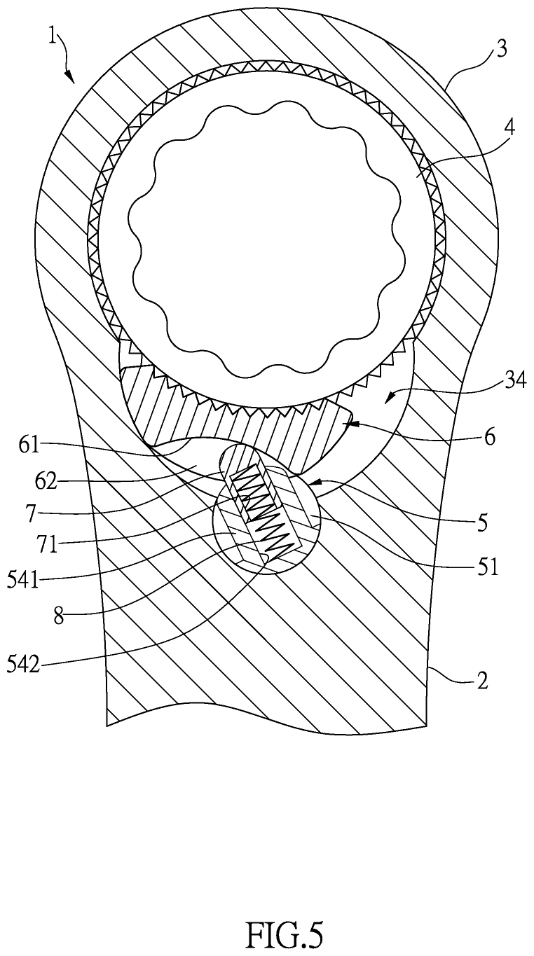

Referring to FIGS. 1 to 6, the ratchet wrench 1 of the present invention comprises a handle 2 and a head 3 which is formed to one end of the handle 2. The head 3 includes a through hole which forms a first opening 31 and a second opening 35 in two opposite sides of the head 3. A recess 34 is defined in the inner periphery of the through hole, and a circular hole 32 is defined through the neck of the head 3 and communicates with the recess 34.

A ratchet wheel 4 is rotatably received in the through hole of the head 3 and located corresponding to the first and second openings 31, 35. A C-clip is used to position the ratchet wheel 4 in the head 3 and prevents the ratchet wheel 4 from dropping from the first opening 31. The ratchet wheel 4 includes a mounting hole 41.

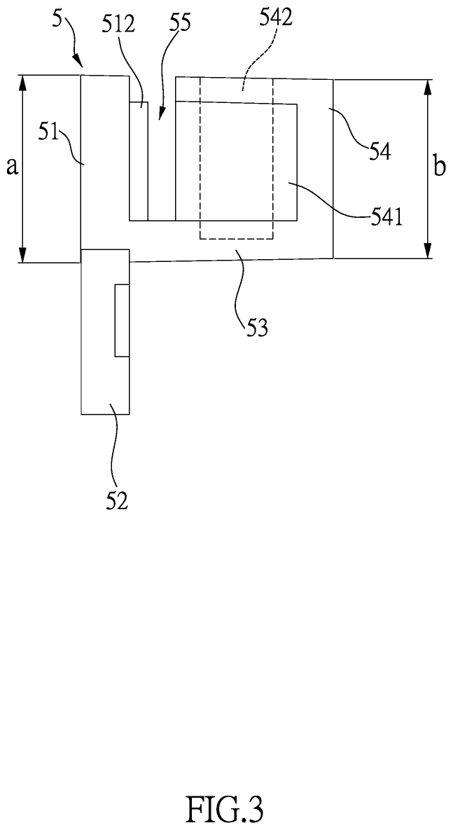

A switch member 5 includes a head end 51, a tail end 54 and a connection portion 53 that is formed between the head end 51 and the tail end 54. A lever 52 extends perpendicularly from the head end 51. The tail end 54 has an extension portion 541 extending therefrom and toward the head end 51. The extension portion 541 is not connected to the head end 51. The tail end 54, the extension portion 541 and a portion of the connection portion 53 are inserted into the circular hole 32 and located in the recess 34. The head end 51 and the lever 52 are located outside of the head 3. As shown in FIG. 3, a first width “a” of the head end 51 is larger than a second width “b” of the tail end 54. The outside of the connection portion 53 is tapered from the outer edge of the head end 51 toward the tail end 54. A gap 9 is formed between the connection portion 53 and the inside of the recess 34.

The head 3 of the ratchet wrench 1 includes a fan-shaped recessed area 33 which is formed to communicate with the circular hole 32. The head end 51 and the lever 52 are located in the fan-shaped recessed area 33. The lever 52 is pivoted between two insides of the fan-shaped recessed area 33. The lever 52 includes two stops 521 respectively protruding from two sides thereof. When either of the stops 521 contact the insides of the fan-shaped recessed area 33, the lever 52 is stopped.

A pawl 6 is movably located in the recess 34. The pawl 6 has a toothed front face and a curved-recessed back 61 which is located opposite to the toothed front face. The pawl 6 is located between the ratchet wheel 4 and the switch member 5, and the toothed front face of the pawl 6 is engaged with the ratchet wheel. A flange 62 extends from the curved-recessed back 61 and located between the head end 51 and the extension portion 541, so that the flange 62 restricts the switch member 5 from dropping from the circular hole 32. A tubular member 7 has a first end thereof contacting the curved-recessed back 61. A spring 8 is biased between a second end of the tubular member 7 and the extension portion 541. Specifically, the second end of the tubular member 7 has a reception hole 71. A dent 542 is defined in the outside of the extension portion 541. The spring 8 has one end thereof inserted in the dent 542, and the other end of the spring 8 is received in the reception hole 71.

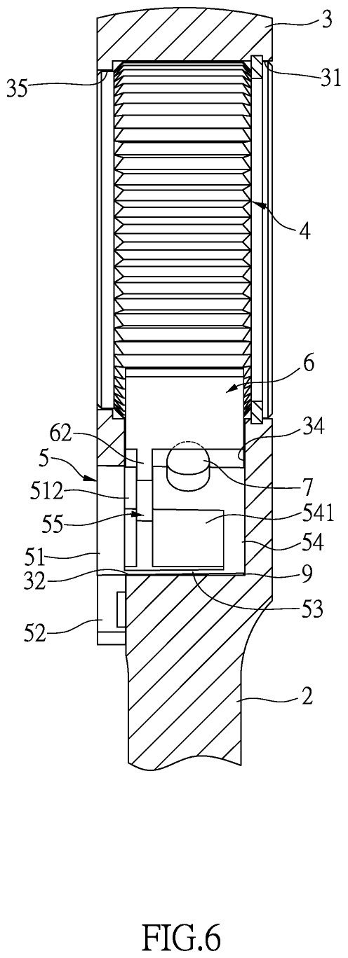

It is noted that because the first width “a” of the head end 51 is larger than the second width “b” of the tail end 54, so that the switch member 5 is like a cone-shaped member which is easily inserted into the circular hole 32 of the head 3. As shown in FIG. 6, the gap 9 ensures that switch member 5 is easily to be operated.

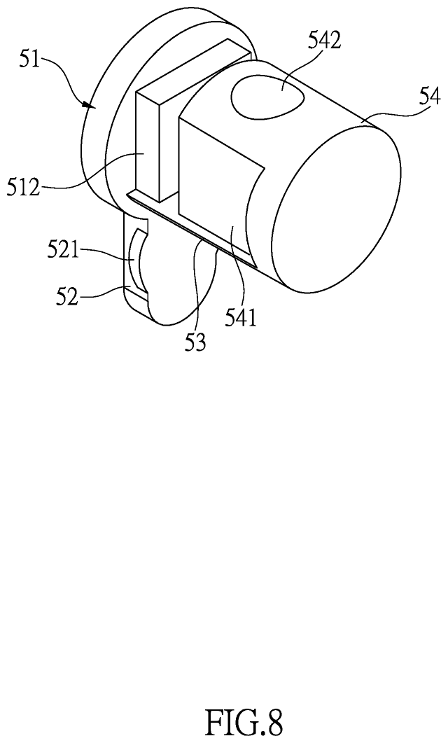

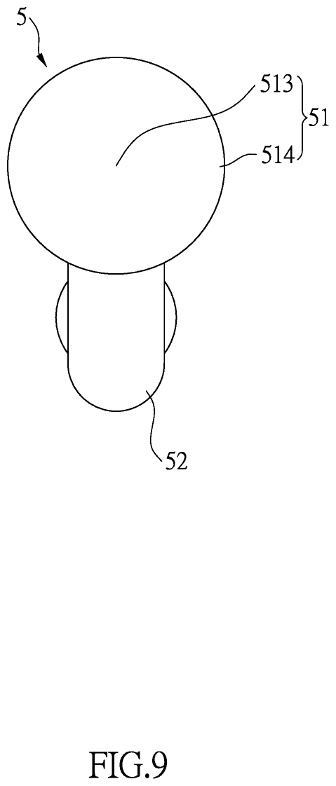

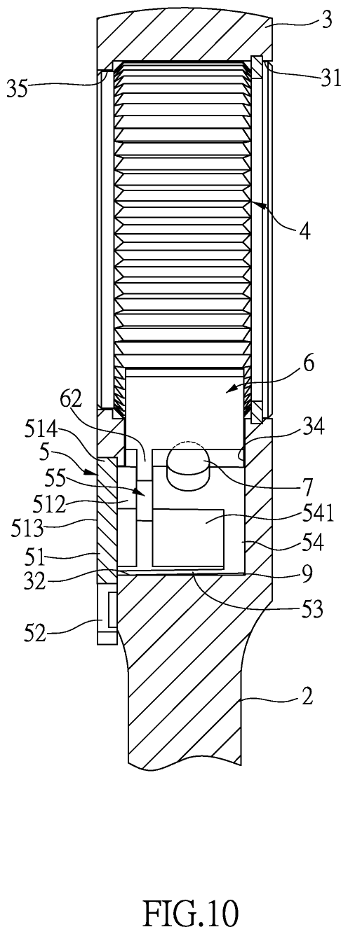

FIGS. 8 to 10 show another embodiment of the switch member 5, wherein the head end 51 includes a central portion 513 and a peripheral portion 514. The central portion 513 is formed at the central portion of the peripheral portion 514, and the central portion 513 is formed with the connection portion 53. The diameter of the peripheral portion 514 is larger than that of the circular hole 32 so that the peripheral portion 514 restricts the head end 51 from entering into the circular hole 32. This ensures that the connection portion 53 cannot be tilt relative to the circular hole 32, and the friction between the connection portion 53 and the circular hole 32 is not increased. A slot 55 is formed between the extension portion 541 and the head end 51. The flange 52 of the pawl 6 is located in the slot 55.

As shown in FIGS. 1, 3 and 6, the head end 51 includes a protrusion 512 which is located in the slot 55 and located in the slot 55. The flange 52 of the pawl 6 is located between the protrusion 512 and the extension portion 541 so that the switch member 5 does not shake when being operated.

While we have shown and described the embodiment in accordance with the present invention, it should be clear to those skilled in the art that further embodiments may be made without departing from the scope of the present invention.

What is claimed is:

1. A ratchet wrench comprising:
a handle and a head which is formed to one end of the handle, the head including a through hole which forms a first opening and a second opening in two opposite sides of the head, a recess defined in an inner periphery of the through hole, a circular hole defined through the head and communicating with the recess;
a ratchet wheel rotatably received in the through hole of the head and located corresponding to the first and second openings;
a switch member having a head end, a tail end and a connection portion that is formed between the head end and the tail end, a lever extending from the head end, the tail end having an extension portion extending therefrom and toward the head end, the tail end, the extension portion and a portion of the connection portion being inserted into the circular hole and located in the recess, the head end and the lever located outside of the head, a first width of the head end being larger than a second width of the tail end, the connection portion being tapered from the head end toward the tail end, a gap formed between the connection portion and an inside of the recess;
a pawl movably located in the recess, the pawl having a toothed front face and a curved-recessed back which is located opposite to the toothed front face, the pawl located between the ratchet wheel and the switch member, the toothed front face of the pawl engaged with the ratchet wheel, a flange extending from the curved-recessed back and located between the head end and the extension portion, the flange restricting the switch member from dropping from the circular hole, and
a tubular member having a first end thereof contacting the curved-recessed back, a spring biased between a second end of the tubular member and the extension portion.

2. The ratchet wrench as claimed in claim 1, wherein the head end includes a central portion and a peripheral portion, the central portion is formed at a central portion of the peripheral portion, the central portion is formed with the connection portion, a diameter of the peripheral portion is larger than that of the circular hole.

3. The ratchet wrench as claimed in claim 1, wherein an outside of the connection portion is tapered from an outer edge of the head end toward the tail end.

4. The ratchet wrench as claimed in claim 1, wherein the second end of the tubular member has a reception hole, a dent is defined in an outside of the extension portion, the spring has one end thereof inserted in the dent.

5. The ratchet wrench as claimed in claim 1, wherein the head includes a fan-shaped recessed area which is formed to communicate with the circular hole, the head end and the lever are located in the fan-shaped recessed area, the lever is pivoted between two insides of the fan-shaped recessed area, the lever includes two stops respectively protruding from two sides thereof, when either of the stops contact the insides of the fan-shaped recessed area, the lever is stopped.

6. The ratchet wrench as claimed in claim 1, wherein a slot is formed between the extension portion and the head end, the flange of the pawl is located in the slot.

7. The ratchet wrench as claimed in claim 6, wherein the head end includes a protrusion which is located in the slot, the flange of the pawl is located between the protrusion and the extension portion.
